(19) United States
(12) Patent Application Publication
(10) Pub. No.: US 2013/0046852 A1
(43) Pub. Date: Feb. 21, 2013

(54) System for Remote Access to a Computer Using a Mobile Device as a Gateway

(71) Applicants: Anurekh Saxena, Newcastle, WA (US); Tejasvi Aswathanarayana, Salem, NH (US)

(72) Inventors: Anurekh Saxena, Newcastle, WA (US); Tejasvi Aswathanarayana, Salem, NH (US)

(73) Assignee: Antecea, Inc., Cambriage, MA (US)

(21) Appl. No.: 13/586,153

(22) Filed: Aug. 15, 2012

Related U.S. Application Data
(60) Provisional application No. 61/523,424, filed on Aug. 15, 2011.

(51) Int. Cl. G06F 15/16

(52) U.S. Cl. 709/217

(57) ABSTRACT

A combination of a mobile device, such as a smartphone, and an installed application allows the mobile device to act as a gateway to allows remote access to a base computer from a remote computer. The mobile device is able to establish a connection with abase computer and will relay screen displays and commends to and from a remote system, to the base system.

### FIELD OF THE INVENTION

The invention is related to the field of mobile computing, and, in particular to the use of non-mobile computing platforms as a base from which to perform various mobile functions.

### BACKGROUND OF THE INVENTION

Many methods and systems currently exist which allow remote access to a non-mobile computing platform (i.e., a home computer or a computer at one's office), referred to herein as the “base” computer. There are varying degrees of such access, from allowing the viewing and manipulation of the actual desktop and the running of applications on the non-mobile computer, to merely allowing remote access to files stored on the non-mobile computer. Microsoft's Remote Desktop Protocol (RDP) and the open source Virtual Network Computing (VNC) facilities, for example, allow complete desktop access to a base computer from a remote computer, with the ability to run applications on the base computer. File Transfer Protocol (FTP), on the other hand is a protocol that only allows the transfer of files from one computer to another.

There are several drawbacks with currently existing solutions which allow remote computing, and, in particular remote desktop access. First, there may be security concerns. Often, it will be necessary to enter validation information for the base computer into the remote computer to gain access to the base computer. Such information may be accessible after the fact on the remote computer and may present a security concern, for example, if the remote system is a publically accessible computer.

Secondly, some computers, such as an office computer in a controlled environment, may not have and also not allow the installation of the necessary software to allow the computer to act to remotely access a base computer, or, simply may not allow the running of software which connects to remote systems. Often, computers in office environments or publically accessible computers are “locked down” such that the user may not have the privileges required to install or run the necessary software. In addition, even if software is available that allows remote access, differences in what is required by the base computer (RDP for example) and what is available on the remote computer (a VNC client, for example) may not be compatible.

Lastly, the user may be unable to maintain access to the base computer if the remote computer is mobile (i.e., actually moving) and not in constant contact with a WiFi hot spot or other means of connecting to the Internet.

Therefore, it would be desirable to have a means of remotely accessing a base computer which eliminates these drawbacks, while still providing the advantages of currently-existing remote access protocols, including file access and screen access protocols.

### DESCRIPTION OF THE DRAWINGS

FIG. 1 is a schematic showing the topology of a system drawn to the present invention.

FIG. 2 is a schematic drawing of a typical mobile device configured in accordance with the present invention.

### DETAILED DESCRIPTION OF THE INVENTION

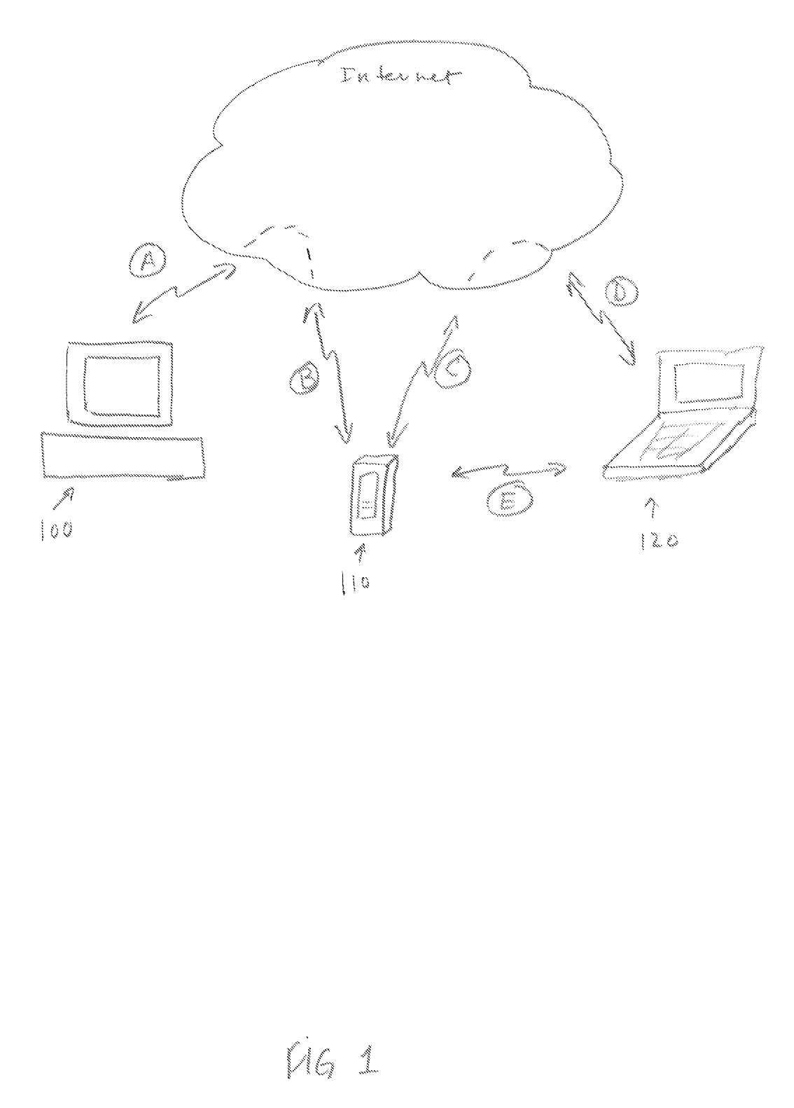

FIG. 1 shows the topology of the present invention in schematic form. In general, the invention allows mobile device 110 to act as a gateway between a remote system 120 and a base computer 100. Mobile device 110 may be, for example, a smartphone or tablet computer.

Systems currently exists implementing a portion of this invention. For example, applications such as Desktop Connect™ by Anteca, Inc. provide a system which allows remote access to the desktop of a base system 100 directly from a mobile device 110. Such applications, however, may be limited in their usefulness because of the differences in screen size between mobile device 110 and base computer 100.

The present invention extends prior art systems by enabling mobile device 110 to serve the desktop of base computer 100 to remote system 120 and to relay user commands typed in at remote system 120 to base computer 100.

In operation, a user using remote system 120 utilizing a standard Internet web browser 122, may access mobile device 110 by typing in the IP address of mobile device 110 or otherwise gaining access to mobile device 110. A connection is thereby established between remote system 120 and mobile device 110 utilizing path C-D as shown in FIG. 1. This connection may be achieved utilizing any well known desktop streaming protocol, such as Microsoft RDP, VNC or other known or later developed protocols, including proprietary and encrypted protocols.

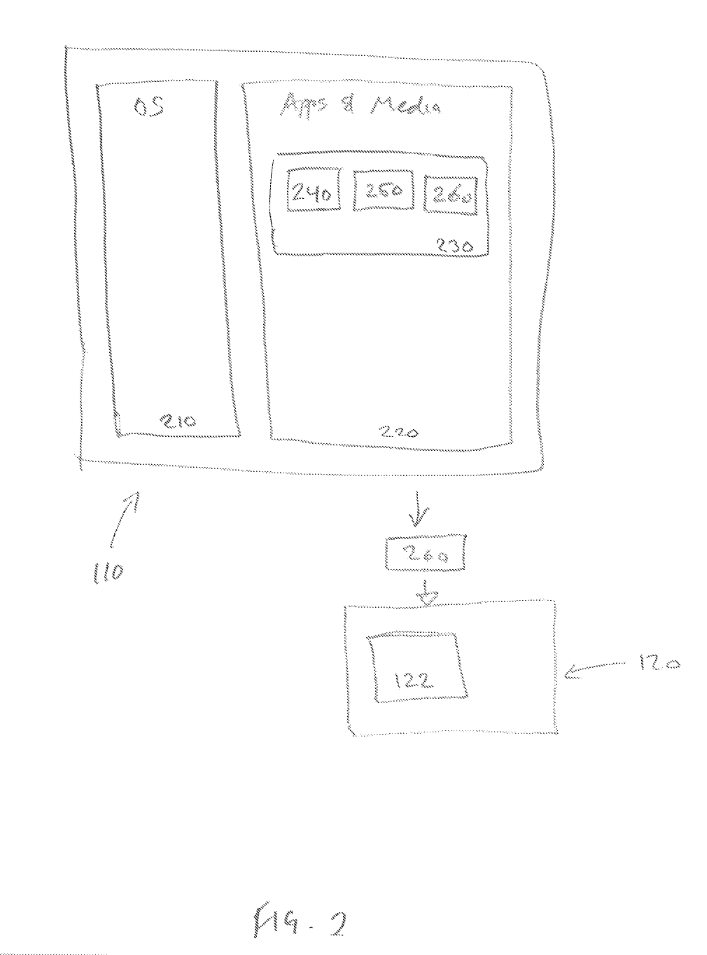

Mobile device 110 is shown schematically in FIG. 2, and is a typical smartphone-type device having an operating system 210 and an application/media storage area 220. The present invention is in the form of a gateway application 230 which is downloaded to mobile device 110 and stored in the application/media storage area 220. Gateway application 230 consists of software which is able to serve a desktop image from base computer 100 to remote system 120. In addition, access information for the base computer 100 is stored in area 240 within the application and protocol translation software 250 is also part of gateway application 230.

Once a request is made from the remote system 120 to the mobile device 110 via path C-D, mobile device 110 makes a request to base computer 100 via path A-B to initiate the remote desktop session. Note that path A-B need not run the same protocol as path C-D. Gateway application 230 on mobile device 110 is able to negotiate and establish the connection to base computer 100, regardless of obstacles such as firewalls. This provides an advantage because remote system 120 may not be able to breach a firewall on base computer 100 to establish a connection.

Mobile device 110 will stream a combination of HTML and a thin-client application 260 to browser 122 running on remote system 120. Thin-client application 260 running on remote system 120 works with gateway application 230 running on mobile device 100 and allows remote system 120 to access the display (via, for example, either an applet (Java) or a flash-based app) of base computer 100. Thin-client application 260 talks to gateway application 230 which forwards/redirects displays and requests in the appropriate manner.

Once a remote desktop session is established between mobile device 110 and base computer 100, mobile device 100 is able to relay the desktop image from base computer 100 to remote system 120 and is able to relay commands from remote system 120 to base computer 110.

The use of mobile device 110 as an intermediary between remote system 120 and base computer 110 solves the problems inherent in the prior art remote desktop scenario as outlined in the background of the invention above. First, it is not necessary for a user at remote system 120 to enter access information for base computer 100. Instead, this information is pre-stored on mobile device 110 and used to automatically establish the connection between mobile device 110 and base computer 100. This eliminates any concern in typing in access information to a remote system 120 that may be, for example, a publicly accessible computer.

Second, the topology of the present invention solves the problem of a user having limited access or privileges on remote system 120 which may limit his ability to install or use software. In utilizing this topology, no software installation is necessary on remote system 120. Remote system 120 is only required to have standard Internet web browsing software installed. The only software installation necessary is the installation of gateway application 230 within the application/media storage area 220 of mobile device 110 (although base computer 100 may need to be configured to allow remote desktop access via any number of different protocols). The connection between remote system 120 and mobile device 110 is made via a standard web browsing program 122 such as Internet Explorer, Chrome or Firefox.

Lastly, mobile device 110 is capable of doing protocol translations between the protocol being used on path C-D and the protocol being used on path A-B via the protocol translation functionality 250. This allows mobile device 110 to act as a truly mobile gateway. For example, in a scenario where the user has a mobile device 110 and a laptop computer acting as a remote system 120 and is actually mobile (i.e., for example, in a moving vehicle), mobile device 110 may be able to establish a connection via path A-B to base computer 110 utilizing any protocol over a network, for example, a cellular data network such as AT&T's 3G or 4G network, or via a mobile WiFi connection, or via any other known or later developed means of connection which allows access from a mobile device. In addition, mobile device 110 need not be stationary, for example, near a WiFi hotspot, to provide access to base computer 100 from remote system 120.

In other aspects of the invention, it is possible that the path A-B from base computer 100 to mobile device 110, as well as the path from mobile device 100 to remote system 120 may utilize any now existing or later developed protocol. In addition, the connection between the devices is not necessarily meant to limit the scope of the invention. For example, remote system 120 may connect to mobile device 110 through an interface which does not involve connecting to the Internet, for example, a connection requiring proximity between remote system 120 and mobile device 110, for example, hard wired, BlueTooth, NFC, infrared, or any other means of connecting two devices locally may be used to establish the connection via path E. Remote system 120 may also connect to mobile device 110 through the Internet via a WiFi, or cellular data connection. Note that there is no requirement that mobile device 110 and remote system 120 be in close physical proximity to each other, unless required to establish a connection via path E requiring close physical proximity, such as BlueTooth or NFC.

In yet another aspect of the invention, connections as described herein may be linked up in daisy-chain fashion to create multiple hop connections from remote computer 120 to base computer 100 (not shown).

The invention has been explained in terms of specific embodiments which are not meant to be limiting in any way. Persons having skill in the art may envision alternative embodiments which are still within the scope of the invention.

We claim:

1. A mobile gateway system for remote access to a base computer, comprising:
a mobile computing device having software installed thereon, said software performing the functions of:
accepting requests for connection from a remote system to said base computer;
establishing a connection to said base computer;
serving a user interface from said base computer to said remote computer; and
relaying inputs from said remote computer to said base computer.

2. The system of claim 1 wherein said software further comprises:
a access portion for storing and retrieving access information for said base computer;
a translation portion for translating between a first protocol used to communicate with said base computer and a send protocol used to communicate with said remote computer; and
a thin client portion for transferring to said remote computer.

3. The system of claim 1 wherein said connection established between said mobile computing device and said base computer is a remote desktop connection and further wherein an image of the desktop of said base computer is relayed to said remote computer.

4. The system of claim 1 wherein said mobile computing device is connected to the internet and further wherein said connection to said base computer is established via the internet.

5. The system of claim 1 wherein said mobile computing device uses WiFi or a cellular data network to connect to the internet.

6. The system of claim 1 wherein said software performs the further function of transferring a thin client application from said mobile computing device to said remote computer to facilitate the serving of the user interface of said base computer to said remote computer.

7. The system of claim 1 wherein said connection between said mobile computing device and said base computer uses a first communication protocol and said connection between said mobile computing device and said remote computer uses a second communication protocol, said software performing the further function of translating between said first protocol and said second protocol.

8. The system of claim 4 wherein said connection between said mobile computing device and said remote computer is established via the internet.

9. The system of claim 1 wherein said connection between said mobile computing device and said remote computer is established without use of the internet.

10. The system of claim 9 wherein said connection between said mobile computing device and said remote computer is established via a proximity connection.

11. The system of claim 1 wherein said mobile computing device may connect through one or more other mobile computing devices, in daisy chain fashion, before reaching said remote computer or said base computer.

12. The system of claim 1 wherein said connection between said remote computer and said mobile computing device uses a desktop streaming protocol.

13. The system of claim 12 wherein said desktop streaming protocol is selected from a group consisting of Microsoft RDP or VNC.

14. The system of claim 1 wherein said connection between said base computer and said mobile computing device uses a desktop streaming protocol.

15. The system of claim 12 wherein said desktop streaming protocol is selected from a group consisting of Microsoft RDP or VNC.

16. The system of claim 6 wherein said thin client on said remote computer may utilize a Java applet or a Flash-based application to render the display of said base computer.

17. The system of claim 1 where access information for said base system is pre-stored on said mobile computing device using said software.
